(19) United States
(12) Patent Application Publication
(10) Pub. No.: US 2009/0026828 A1
(43) Pub. Date: Jan. 29, 2009

(54) Seat belt apparatus

(76) Inventors: Julius Adomeit, Berlin (DE); Steve Marshall, Workington (GB)

Correspondence Address: DELPHI TECHNOLOGIES, INC., M/C 480-410-202, PO BOX 5052, TROY, MI, 48007, US

(21) Appl. No.: 12/151,435

(22) Filed: May 6, 2008

(30) Foreign Application Priority Data
Nov. 9, 2005 (EP) 05024419.3
Oct. 25, 2006 (EP) PCT/EP2006/010282

(51) Int. Cl. B60R 22/34; B60R 21/00; B60R 22/46

(52) U.S. Cl. 297/477; 242/374; 280/807; 280/806

(57) ABSTRACT

The invention relates to a seat belt apparatus for motor vehicles comprising a seat belt, a belt retractor and a drive, which preferably comprises an electric motor, for the retractor, wherein a unidirectionally effective blocking member is integrated into the powertrain between the drive and the retractor which, starting from a normal blocking state, amplifies the blocking effect with a force transmission starting from the belt and reverses it into a release state with a force transmission starting from the drive.

### TECHNICAL FIELD OF INVENTION

The invention relates to a seat belt apparatus for motor vehicles comprising a seat belt, a belt retractor and a drive for the retractor.

### BACKGROUND OF INVENTION

Seat belt apparatuses of this kind are generally known. For example, a so-called pre-safe function or pre-crash function can be realized by means of the drive in that e.g., in the event of an accident, directly before the impact of the vehicle on an obstacle, or due to a warning signal which generates a warning function implemented in the vehicle e.g. by a permanent evaluation and assessment of the traffic situation on the occurrence of a dangerous situation satisfying specific pre-settable conditions, the retractor is driven in the wind-up direction in order to ensure that the belt tightly contacts the body of the respective vehicle occupant in good time. It is a problem here that these belt systems should be resettable, since the belt has to be relaxed again if the expected impact does not take place or an all-clear signal is given. In addition, the belt systems should be in a position to keep the belt in the pre-tensioned or pre-tightened state in the time period between the first pre-tensioning or pre-tightening of the belt and the release of the belt on the non-occurrence of the expected accident or on the all-clear signal.

If an electric motor is used for the drive of the belt retractor, the problem exists that the motor has to be switched on permanently to hold the pre-tensioned belt, which can result in an overheating or overloading of the motor. To avoid this problem, the normal belt locking, also known as “main locking”, of the retraction device can be used to hold the belt subsequently to the pre-tensioning, without an electric motor providing this belt pre-tension having to remain activated. However, it is now a problem that the belt locking has to be released for the mentioned relaxing of the belt on the non-occurrence of the expected impact or accident or on the all-clear signal, which requires, as is known, a second pulling on the belt. In this procedure, the belt is therefore pulled twice one after the other within a short period: the first time to pre-tension the belt and the second time to release the belt lock. The second pulling on the belt—known as the “second stroke” problem—is not only felt to be irritating by the affected occupant, but can also result in dangerous reactions of the occupant, since the “second stroke” takes place surprisingly for the occupant without a danger situation recognizable by him.

If a friction-locking transmission is provided between the motor and the retractor instead of the normal belt lock and is able to hold the pre-stressed belt when the motor is switched off and which can be overcome subsequent to the holding phase by the motor switched on again to relax the belt again, then the mentioned second stroke problem can hereby be avoided. However, the relatively large friction losses of a mechanical holding device based on the principle of friction locking are problematic in this arrangement. The friction losses have to be balanced via the electric motor, i.e. have to be “added to” the system, which has the consequence of increased energy requirements and a larger electrical power. This can in turn result in problems with an overheating or overloading of the motor.

It is desirable to provide a seat belt apparatus of the initially named kind which permits both a holding of the belt and a relaxing of the belt taking place thereafter in a manner which is as simple and as reliable as possible subsequent to a pre-tensioning or pre-tightening of the belt while avoiding the “second stroke” problem, with this being able to be realized with a use of energy which is as low as possible.

### SUMMARY OF THE INVENTION

In accordance with an embodiment of the invention, a unidirectionally effective blocking member is integrated into the powertrain between the drive and the retractor and, starting from a normal blocking state, increases the blocking effect with a force transmission starting from the belt and reverses it into a release state with a force transmission starting from the drive.

The unidirectionally effective blocking member differs with respect to its effect according to whether a force transmission is initiated via the powertrain at the drive side or at the belt side. It is ensured by the normal blocking state of the blocking member that the belt is held in the pre-tensioned or pre-tightened state without energy having to be applied for this purpose since the drive is not needed to hold the pre-tensioned state and can therefore be inactive in this holding phase.

The drive can cancel the blocking of the powertrain using a minimal expenditure of energy and drive the belt retractor with the blocking member in the release state by the possibility of reversing the blocking member between the normal blocking state and the release state.

In particular in connection with an intelligent control for an electric motor serving as a drive, the electrical energy requirements, and so the required electrical power, can be reduced to a minimum due to the blocking member. It is in particular thereby possible to use the whole system faster and at a higher frequency than before without an overload or overheating of the drive motor occurring.

The second stroke problem initially explained is also avoided by the invention since the drive for the belt retractor can be used both for the pre-tensioning or pre-tightening of the belt and for the driving of the belt retractor in the reverse direction, that is to unwind the belt. When unwinding the belt, the time development of the belt relaxation can take place directly in accordance with a pre-settable scheme, in particular a scheme which does not disturb the vehicle occupants, in particular advantageous when an electric motor is used.

Alternative embodiments of the invention are also recited in the dependent claims, in the description and in the drawing.

In a further development of the invention, a mechanical energy store can be integrated into the powertrain between the drive and the retractor. The drive can be operated in dependence on a control signal, selectively either in a storage mode decoupled from the retractor for the filling of the energy store or in a wind-up mode in which the drive is coupled to the retractor and the retractor is driven in the wind-up direction by a torque jointly applied by the drive and the previously filled energy store.

In this connection, the blocking member can be arranged between the drive and the mechanical energy store. The blocking member makes it possible to hold the mechanical energy store—for example a tensioned spring—in the filled (or tensioned) state for an unlimited time without a holding torque to be applied by the drive being necessary for this purpose.

The energy requirements required overall for the operation of such a system can therefore also be reduced to a minimum in systems which work with such a mechanical energy store. In the case of use, i.e. when the retractor should be driven in the wind-up direction, with such an energy store, the drive is assisted by the energy store which was previously filled by the drive itself. The circumstance can thus be utilized that sufficient time is available in which the energy store can be filled during normal vehicle operation. For this purpose, the drive is used itself so that no additional systems are required. No excessively high power peaks therefore have to be provided by the drive for the filling of the energy store. In the pre-safe case or the pre-crash case, the required high power is then made available jointly by the drive and the previously filled energy store which then so-to-say “pull in the same direction”.

All further developments of the invention explained in the following can be realized in systems both with and without such a mechanical energy store.

The blocking member is preferably made and integrated such that it amplifies the blocking effect or reverses it into the release stage with a force transmission taking place both in the wind-up direction and in the unwinding direction.

The blocking effect is therefore cancelled with a force transmission initiated by the drive irrespective of whether the drive is operated in the wind-up direction or in the unwinding direction. The powertrain is accordingly blocked by the blocking member irrespective of whether a loading takes place in the wind-up direction or in the unwinding direction with a force transmission initiated at the belt side.

The blocking member is in particular a blocking spring which can be made as a loop spring or as a spiral spring. A blocking spring of this type can be designed such that it is connected in a force transmitting manner in a relaxed normal state to a holding section onto which it is mounted and which is, for example, of spigot-like or bolt-like shape. A blocking spring of this type can be made without problem with sufficient strength to effect a rotationally fixed clamping fit on the holding section which reliably blocks the powertrain on loading at the belt side. “Relaxed” is to be understood here such that no loading of the blocking spring takes place at the belt side or at the drive side, i.e. the blocking effect by “looping” the holding section is achieved by a corresponding pre-tensioning of the blocking spring which endeavors to relax further than the holding section allows.

The blocking spring can have two spaced-apart control sections which cooperate with drive sections on the belt side and on the drive side. When the blocking spring is wound, the control sections can form the ends of the turn.

Provision can be made in this process for the blocking spring to compress by a pressing together of the control sections and to expand by a pressing apart of the control sections, or vice versa, depending on the design. Provision can be made in this process for the blocking spring to amplify the blocking effect by pressing together the control sections and to reverse it into the release state by pressing apart the control sections, or vice versa.

The unidirectional effect of the blocking member can be achieved by a skillful arrangement of its control sections and of the drive sections on the belt side and drive side with which the blocking spring is charged via its control sections.

An inner drive section of the one side, in particular the drive side, can in particular be positioned between the two control sections of the blocking spring, with the inner drive section being positioned together with the control sections between two parts of an outer drive section of the other side, in particular the belt side, having a fixed spacing from one another.

In this arrangement, the drive acts so-to-say from the inside onto the control sections of the blocking spring, whereas the effect takes place from the outside by the belt side.

To ensure a particularly reliable amplification of the blocking effect or a reversal into the release state of the blocking spring, it is preferred for the control sections of the blocking spring to be positioned with clearance between the drive sections. It is thereby ensured that the blocking spring is first charged at the start of a power transmission before the force transmission between the drive side and the belt side is established and the powertrain is either blocked or released more strongly depending on which side the force transmission is initiated from.

The control sections of the blocking spring and the drive sections on the drive side and belt side can be arranged at a radial spacing from a rotary axis of the powertrain to be able to rotate the blocking spring seated on the stationary holding section and the supports for the drive sections on the drive side and on the belt side.

Further features and advantages of the invention will appear more clearly on a reading of the following detailed description of an embodiment of the invention, which is given by way of non-limiting example only and with reference to the accompanying drawings.

### BRIEF DESCRIPTION OF DRAWINGS

This invention will be further described with reference to the accompanying drawings in which:

FIG. 1 shows a perspective exploded views of a partially disassembled section of the powertrain of a seat belt apparatus containing a blocking member;

FIG. 2 shows a perspective exploded views of a section of the powertrain of a seat belt apparatus containing a blocking member;

FIG. 3 shows a seat belt apparatus in the assembled state; and

FIG. 4 shows schematically, an example for the design of the powertrain in the region of the blocking member.

### DETAILED DESCRIPTION OF INVENTION

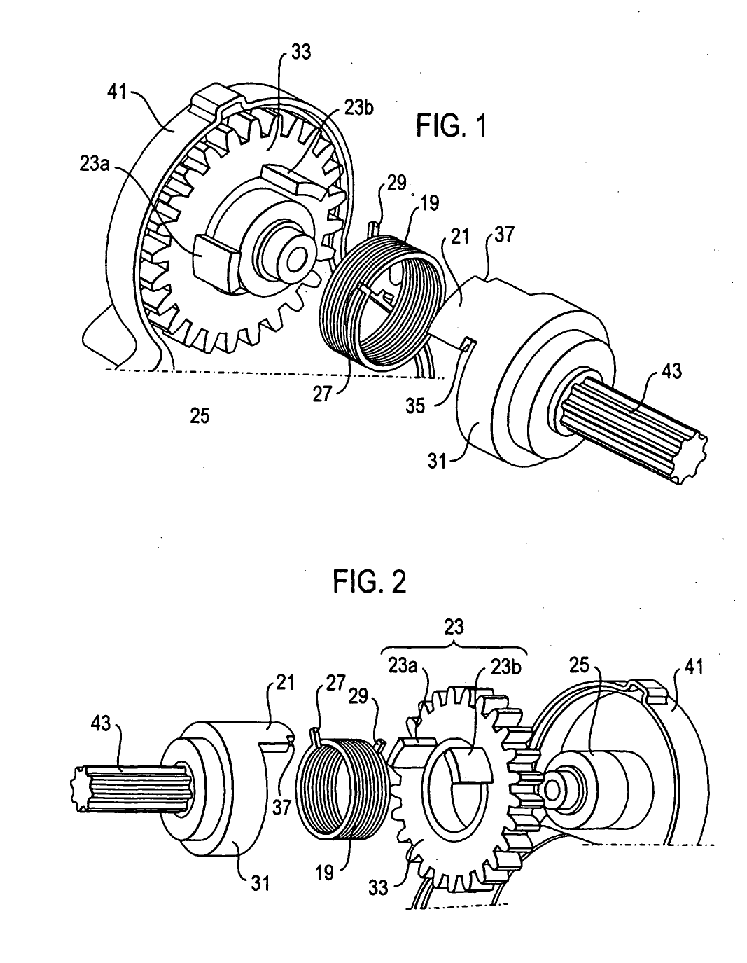

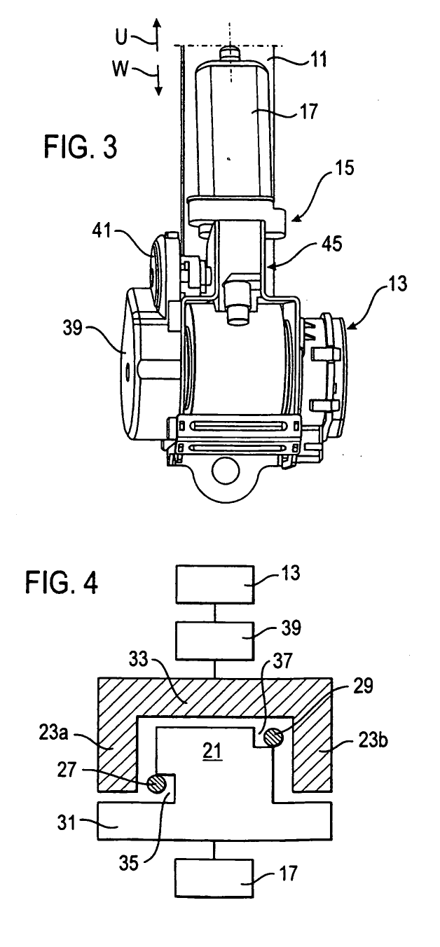

There are visible of the powertrain in FIGS. 1 and 2—between the drive 15 (FIG. 3), comprising an electric motor 17, on the one hand, and the belt retractor 13, on the other side—on the motor side, a drive shaft 43 having a rotationally fixedly connected support 31 for a drive section 21 on the motor side and, at the belt side, a toothed wheel 33 which is arranged in a housing 41 and which serves as a carrier for a drive section 23 on the belt side which is divided into two parts and which comprises two components 23a, 23b spaced apart in the peripheral direction.

The drive sections 21, 23 are made as axial projections which are arranged at a radial spacing from a rotary axis which coincide with the central axes of the drive shaft 43 and of a spigot 25 fixed to the housing. The support toothed wheel 33 at the belt side is rotatably supported on the cylindrical spigot 25.

In the assembled state (FIG. 3, FIG. 4), the drive section 21 on the motor side is located between the two parts 23a, 23b of the drive section 23 on the belt side so that a shape-matched connection is present—viewed in the peripheral direction. This connection has clearance in the peripheral direction, as in particular FIG. 4 shows, i.e. before a force transmission can take place between the drive sections 21, 23, a specific empty distance must be covered by that drive section from which the force transmission starts before the respectively other drive section is taken along. In a practical embodiment, this empty path or “dead path” amounts to only a few degrees.

In accordance with the invention, a blocking member is integrated into the powertrain in the form of a wound loop spring 19 which is likewise seated coaxially to the support toothed wheel 33 on the belt side on the spigot 25 which serves as the holding section to the loop spring 19. The ends of the loop spring 19 are made as radially outwardly projecting control sections 27, 29. The control sections 27, 29 are spaced apart both axially and in the peripheral direction.

FIG. 4 shows that, in the assembled state, the control sections 27, 29 are each positioned between the inner drive section 21 on the motor side and one of the two parts 23a, 23b of the outer drive section 23 on the belt side. In this arrangement, the control sections 27, 29 are disposed in the region of cut-outs 35, 37 which are arranged correspondingly offset axially and in the peripheral direction and which are formed in the drive section 21 on the motor side. The drive section 21 thereby has a Z-like shape. The cut-outs 35, 37 are dimensioned sufficiently largely to be able to accept the control sections 27, 29. Alternatively, the cut-outs 35, 37 can also be made at the two parts 23a, 23b of the outer drive section 23 on the belt side.

The cross-sectional shape of the part, in particular wire-like part, forming the loop spring 19, which is shown in circular shape in FIG. 4, can generally be of any type and can e.g. also be rectangular or square.

FIG. 4 shows the starting state or normal state of the blocking member 19 in which is it not charged either on the motor side or on the belt side. In this state, the control sections 27, 29 of the blocking member 19 are spaced apart—seen in the peripheral direction both from the drive section 21 on the motor side and from the outer parts 23a, 23b of the drive section 23 on the belt side. Considered in the peripheral direction, there is therefore clearance between the individual components in this state.

The loop spring 19 is wound and pre-tensioned such that it endeavors in this unloaded state to compress to an inner diameter which is smaller than the outer diameter of the spigot 25 onto which the loop spring 19 is mounted. In the normal state in accordance with FIG. 4, the loop spring 19 is consequently firmly clamped on the spigot 25 such that a rotationally fixed, force-transmitting connection is present between the loop spring 19 and the spigot 25 fixed to the housing.

The control sections 27, 29 are positioned with respect to the turn of the loop spring 19 such that the loop spring 19 compresses further by pressing together the control sections 27, 29 in the peripheral direction. Vice versa, an expansion of the loop spring 19 is effected by pressing apart the control sections 27, 29 in the peripheral direction. “Compressing” is meant here as a movement of the control sections directed toward the drive section 21 and “pressing apart” as a movement directed away from the drive section 21. On compression or expansion, only at least substantially that control section moves which is charged by the respective drive section, whereas the other control section remains at least substantially in the original position.

The arrangement of the drive sections 21, 23 on the motor side and on the belt side in accordance with FIG. 4 corresponds to this design of the loop spring 19: The drive section 21 on the motor side is located between the two control sections 27, 29 which are in turn engaged around by the two parts 23a, 23b of the drive section 23 on the belt side shaped like a fork to this extent and having a fixed spacing from one another in the peripheral direction.

The following manner of function results from this configuration together with the mentioned clearance between the control sections 27, 29 and the drive sections 21, 23 in the peripheral direction.

If the electric motor 17 is actuated, the drive section 21 on the motor side charges the respective control section 27, 29 irrespective of whether the actuation takes place in the wind-up direction W or in the unwinding direction U (FIG. 3) in the sense that the two control sections 27, 29 are pressed apart from one another in the peripheral direction, i.e. the spacing between the two control sections 27, 29 becomes larger. The loop spring 19 thereby widens, whereby its rotationally fixed clamping fit on the holding spigot 25 is cancelled and the loop spring 19 is thus reversed from the normal blocking state into a release state. In this release state, the loop spring 19 can rotate on the holding spigot 25. A deflection of the respective control section 27, 29 by a few degrees is already sufficient for this reversal.

The deflection of the respective control sections 27, 29 by means of the drive section 21 on the motor side required for the reversal into the release state takes place before the drive section 21 on the motor side abuts the respective part 23a or 23b of the outer drive section 23 on the belt side from the inside.

This means that the charging of the retractor 13 by the motor 17 takes place with a completely cancelled blocking of the powertrain since the loop spring 19 is already in the release state. The cut-outs 35, 37 of the drive section 21 on the motor side serve for the acceptance of the respective control section 27, 29 during the drive of the retractor 13 when the drive section 21 on the motor side inwardly contacts the respective part 23a, 23b of the drive section 23 on the belt side.

Vice versa, a force transmission starting from the belt 11 effects a movement of the respect part 23a, 23b of the drive section 23 on the belt side against the respective control section 27, 29 of the loop spring 19, and indeed before the respective part 23a, 23b abuts the inner drive section 21 on the motor side, irrespective of whether said force transmission takes place in the wind-up direction W or in the unwinding direction U. The control sections 27, 29 of the loop spring 19 are thereby pressed together, i.e. the spacing between the two control sections 27, 29 is reduced, whereby said loop spring endeavors to compress further. The clamping force which holds the loop spring 19 rotationally fixedly on the spigot 25 fixed to the housing is hereby further increased, whereby the blocking effect of the loop spring 19 is amplified.

In accordance with the invention, the powertrain provided with the blocking member 19 is so-to-say admittedly symmetrical with respect to the direction of rotation, but asymmetric with respect to that side from which the force transmission starts due to the unidirectional effect of the blocking member.

In a direction starting from the belt 11, the powertrain is formed so-to-say in a self-locking manner by this asymmetrical action of the loop spring 19. With a force transmission starting from the belt 11, the drive section 23 on the belt side can consequently not rotate, and indeed neither in the wind-up direction W nor in the unwinding direction U, due to the blocking member 19 of the drive section 21 on the motor side active in the blocking direction. Without an actuation of the motor 17, the seat belt 11 is therefore forced to remain in the respectively prevailing tensioning or tightening state.

Once the belt 11 has been tightened by means of the motor 17 in the pre-safe case or the pre-crash state, which takes place with the loop spring 19 reversed into the release state, the motor 17 can be switched off. The loop spring 19, which returns on its own to the blocking state, ensures that the pre-tensioned or pre-tightened state of the belt 11 is held. Forces acting via the belt 11 cannot change this belt state since the blocking member 19 blocks—in both rotary directions—the toothed belt 33 on the belt side which supports the drive section 23.

If the pre-tensioned state of the belt 11 should be cancelled, the motor 17 is actuated in the unwinding direction, whereupon the loop spring 19 is reversed into the release state so that the motor 17 can drive the retractor 13 in the unwinding direction.

In FIG. 4, the possible further development already initially explained is indicated schematically which consists of a mechanical energy store 39, e.g. in the form of a spiral spring, being additionally arranged between the motor 17 and the retractor 13. The energy store 39 is located between the support toothed wheel 33 on the belt side and the retractor 13.

It is of importance that the unidirectional blocking system in accordance with the invention can be used both with and without a mechanical energy store of this type.

While this invention has been described in terms of the preferred embodiments thereof, it is not intended to be so limited, but rather only to the extent set forth in the claims that follow.

Having described the invention, it is claimed:

1. A seat belt apparatus for motor vehicles comprising,
a seat belt;
a belt retractor coupled to the seat belt and operative for releasing and for retracting the seat belt; and
a drive for driving the belt retractor and comprising an electric motor;
a unidirectionally blocking member disposed between the electric motor and the retractor and having a normal blocking state effective to block a force transmission from the belt and a release state in response to a force transmitted by the electric motor.

2. A seat belt apparatus in accordance with claim 1, characterized in that the blocking member amplifies the blocking effect or reverses it into the release state with a force transmission taking place both in the wind-up direction (W) and in the unwinding direction (U).

3. A seat belt apparatus in accordance with claim 2, characterized in that the blocking member is a mechanical blocking member.

4. A seat belt apparatus in accordance with claim 4, characterized in that the blocking member comprises a blocking spring which is in particular made as a loop spring or spiral spring.

5. A seat belt apparatus in accordance with claim 4, characterized in that the blocking spring is seated on a holding section which is decoupled from the powertrain, is stationary with respect to drive sections on the drive side and on the belt side and to which the blocking spring is connected in a force transmitting manner in the blocked state.

6. A seat belt apparatus in accordance with claim 4, characterized in that the blocking spring has two spaced apart control sections which cooperates with drive sections on the belt side and on the drive side.

7. A seat belt apparatus in accordance with claim 6, characterized in that the blocking spring is wound and the control sections form the ends of the turn.

8. A seat belt apparatus in accordance with claim 7, characterized in that the blocking spring is compressed by pressing together the control sections and expands by pressing apart the control sections, or vice versa.

9. A seat belt apparatus in accordance with claim 8, characterized in that the blocking spring (19) amplifies the blocking effect by pressing together the control sections and reverses it into the release state by pressing apart the control sections, or vice versa.

10. A seat belt apparatus in accordance with claim 9, characterized in that an inner drive section of the one side is positioned between the two control sections of the blocking spring, with the inner drive section being positioned together with the control sections between two parts of an outer drive section of the other side having a fixed spacing from one another.

11. A seat belt apparatus in accordance with claim 6, characterized in that, with a blocking spring in the normal state, its control sections are positioned with clearance at least with respect to one drive section, preferably with respect to both drive sections.

12. A seat belt apparatus in accordance with claim 11, characterized in that the inner drive section is associated with the drive side and the outer drive section is associated with the belt side.

13. A seat belt apparatus in accordance with claim 12, characterized in that the control sections of the blocking spring and the drive sections on the drive side and belt side are arranged at a radial spacing from a rotary axis of the powertrain to be able to rotate the blocking spring seated on the stationary holding section and the supports for the drive sections on the drive side and on the belt side.
